(19) United States
(12) Patent Application Publication
(10) Pub. No.: US 2002/0183207 A1
(43) Pub. Date: Dec. 5, 2002

(54) Conducting material

(76) Inventors: Olof Hjortstam, Vasteras (SE); Peter Isberg, Vasteras (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/048,889

(22) PCT Filed: Mar. 30, 2001
(86) PCT No.: PCT/SE01/00698

(30) Foreign Application Priority Data
Mar. 30, 2000 (SE) 0001123-9
Oct. 30, 2000 (SE) 0003944-6

(51) Int. Cl. H01B 1/00

(52) U.S. Cl. 505/100

(57) ABSTRACT

Conducting material for an electric conductor comprising nanostructures (31) and a charge-transfer agent that shifts the nanostructures' fermi level so that said nanostructures attain an enhanced conductivity.

### TECHNICAL FIELD

The present invention relates to an electric conductor. More particularly the invention concerns conducting material containing nanostructures having an enhanced electric conductivity.

### TECHNICAL BACKGROUND

Electrons in an atom can only have certain well-defined energies. The electrons occupy particular energy levels within the atom depending on their energy. Each energy level can accommodate only a limited number of electrons.

If two similar atoms are brought near enough to each other so that they interact, the two-atom system has two adjacent energy levels corresponding to each energy level in the single atom. If ten atoms interact, the ten-atom system has ten energy levels corresponding to each energy level in the individual atom. For solids, the number of atoms and therefore the number of energy levels are very large. A lot of the higher energy levels overlap and merge into regions of allowed energy levels called energy bands. Regions containing no energy levels, called bandgaps, separate the energy bands.

A valence band is the highest energy band occupied by electrons. The valence band in a metallic material is partly filled with electrons and there is no bandgap in the vicinity of electrons in this energy region. The valence band of a metallic material is also the conduction band.

In an insulator electrons till the whole valence band and there is a large bandgap between the valence band and the next energy band, the conduction band. Electrons can only move into the conduction band if they gain enough energy to be excited over the large bandgap.

In a semiconductor the bandgap between the valence band and the conduction band is much smaller than in an insulator. At room temperature the valence band is almost completely filled with electrons. Electrons which gain enough thermal energy to be excited over the bandgap to the conduction band are missing from the valence band. The holes left behind in the valence band behave like positive charge carriers. Semiconductors are doped to change their conductivity. Dopants are classified as either donors or acceptors of charge carriers. A donor donates an electron to the semiconductor, an acceptor removes an electron from the semiconductor which creates a hole in the semiconductor's valence band.

In a metallic material the fermi energy is the highest energy of a single electron in material in it's ground state. Energy levels lower that the fermi energy are filled with electrons and energy levels higher than the fermi energy are unoccupied. Strictly speaking this is only ever achieved at absolute zero and the fermi energy then coincides with the chemical potential. At temperatures higher than absolute zero, a metallic material's fermi level is the highest occupied energy level in the material. The fermi level is the energy level having the probability that it is exactly half filled with electrons.

In insulators and semiconductors the fermi energy is located in the middle of the bandgap. Electrons in the completely or almost completely filled valence band require a lot of energy to move into an unoccupied allowed energy level in the conduction band.

A material's fermi energy is changed when its, electrons absorb or emit energy or when electrons are added to or removed from the material. An electron occupying an energy level under the fermi level can only be excited if it is supplied with energy corresponding to at least the energy difference between the electron's energy level and the fermi level.

The vacuum level corresponds to the minimum energy that an electron at the fermi level requires in order to leave a material. When two materials having different fermi levels and with the same vacuum level are brought into electric contact, electrons from the material with the highest energy level are transferred to the other material. This charge transfer raises the lower fermi level and lowers the higher fermi level. When the charge transfer is complete, the fermi levels of the two electrically connected materials are the same.

A metallic conductor's conductivity is limited by the scattering of its electrons. The conductor's atoms are fixed in a lattice but they vibrate because of their thermal energy. Collisions between electrons and these vibrating atoms give rise to scattering. An electron's mean free path is the mean distance an electron travels before it is scattered.

Recently there has been a lot of interest in conducting structures called quantum wires. These structures have a small area that limits charge carriers to a cross-sectional area that is comparable with the charge carriers' de Broglie-wavelength. The transport of electrons in these types of conductor is ballistic if the charge carriers do not experience any scattering. In other words a conductor is a ballistic conductor if the charge carriers' mean free path is greater than the conductor's length. In this type of conductor the conductivity, G

$$G = \frac{2 {e}^{2}}{h} MT = {G}_{0} MT$$

where e is unit charge, h is Planck's constant, M is the number of energy levels at the fermi level and T is the transmission probability which gives the probability that an electron will be transferred through the conductor. The constant G₀≈(12,9 kΩ)⁻¹ is called the conductivity quantum. If there is no reflection at the conductor's contact points and no scattering within the conductor, T=1.

In 1985 hollow spherical/tubular molecules consisting of sp²-hybridised carbon called fullerenes were discovered (See “C₆₀: Buckminsterfullerene”, Kroto H. W, Heath J. R, O'Brien S. C, Curl R. F and Smalley R. E, Nature vol. 318, p162, 1985). Fullerenes exist in many structures including open or closed, single- or multi-wall nanotubes. The helical structure and diameter of a carbon nanotube can be represented by the vector, C, connecting two crystallographically equivalent sites on a sheet of graphite, where;

C=na₁+ma₂≡(n,m)

and n and m are integers where n≧m, and a₁ and a₂ are the graphite structure's unit vectors. A cylinder is formed when a graphite sheet is rolled up in such a way that the vector's two end points i.e. the two crystallographically equivalent sites, are superimposed. m=0 for all zig-zag tubes and n=m for all airmchair-type tubes. All carbon nanotubes can be described by two figures (n,m).

Carbon nanotubes can have either metallic or semiconducting properties depending on their diameter and helicity, as described by White C. T, Robertson D. H, and Mintmire J. W, Phys. Rev. B47, pp5485-5488, 1993; “Abstract of Second C60 Symposium”, Endo M, Fujiwara H, Fukunga E,

Japan Chemical Society, Tokyo, pp101-104, 1992. Nanofibres can be produced from metallic carbon nanotubes and it has been suggested that these can be used as conducting material in power cables. (See WO 98 39250). Approximately ⅓ of all possible single-wall carbon nanotube structures are metallic. It has been shown that ballistic transport can occur in metallic carbon nanotubes having a length up to 10 μm (see White C. T and Todorov T. N, Nature 393, 240 1998). When they condense, single-wall carbon nanotubes have a tendency to form groups containing 10 to 1000 parallel single-wall carbon nanotubes. These so-called nanoropes held together by Van der Waals forces. A bandgap can arise in such nanoropes because of the interaction between individual carbon nanotubes.

A single-wall carbon nanotube has two energy bands at its fermi energy. If current is conducted at a single-wall metallic carbon nanotube's fermi energy the conductivity is therefore 2G₀. This is a fundamental limitation for of the carbon nanotube's conductivity and is determined by the number of energy levels that cross the fermi level. If a single-wall metallic (10,10) carbon nanotube's fermi level is shifted up or down so that more energy levels cross the fermi level, the conductivity increases in steps of 4G₀ to 6G₀, 10G₀ etc. In order to reach the first step, i.e. to increase the conductivity from 2 to 6G₀, the fermi level must be shifted up or down by about 0.8 eV (see Tomanek D and Enbody R. J, Science and Application of Nanotubes, Kluwer Academic/Plenum Publishers, 2000, p339). Theoretical estimates predict that in order to impart the necessary shift in the fermi level of a metallic (10,10) carbon nanotube, to increase the conductivity from 2G₀ to 6G₀, a charge transfer corresponding to about 0.02 electrons per carbon atom is required.

### SUMMARY OF THE INVENTION

An aim of the present invention is to produce nanostructure-based conducting material with enhanced electric conductivity. Another aim is to increase the conductivity of both metallic and semiconducting nanostructures in nanostructure-based conducting material.

These aims of the present invention are achieved by producing conducting material according to the characterizing part of claim 1 and using a method according to the characterizing parts of claims 18, 23 and 24. Advantageous embodiments of the invention are given in the characterizing parts of the dependent claims.

Advantageous embodiments are achieved by shifting the fermi energy of nanostructures. The term nanostructures includes all structures with a diameter in the order of nanometers, which in practice means a diameter between 0,1 and 100 nanometers. It includes open and closed, single- and multi-wall nanotubes, fullerenes, nanospheres, nanoropes, nanoribbons and nanofibres, as well as nanotubes, nanoropes, nanoribbons or nanofibres woven, plaited or twisted into a layer or a sheath.

A material's fermi level varies with the material's composition. A nanostructure's fermi level can be shifted by applying a suitable dopant to its surface or by intercalating which involves inserting or incorporating ions, atom or molecules of an intercalant into structures such as nanoropes and nanofibres. In a preferred embodiment of the invention the intercalant is arranged to decrease the interaction between nanostructures. Dopants and intercalants contribute to charge transfer between themselves and the nanostructures by transferring charge carriers to or from the nanostructures. Dopants and intercalants will be referred to as charge-transfer agents in the remainder of this document. Charge-transfer agents are applied either inside nanostructures' inner cavities or on their outer surface.

Suitable charge-transfer agents include, for example, an alkali metal such as lithium, sodium or potassium, an alkali earth metal such as calcium, strontium or barium, a transition metal such as manganese, iron, nickel, cobalt or zinc or a metal compound such as MgCl₂, FeCl₂, FeCl₃, NiCl₂, AlCl₃, or SbCl₅, a halogen such as bromine, chlorine or iodine, a binary halogen compound such as iodochlorine or iodobromine, an acid such as HNO₃, H₂SO4, HF or HBF₄, a polymer or hydrogen.

Alkali metals work well as charge-transfer agents. They have a valence electron that is easily donated because of the atom's low ionization energy, however alkali metals are thermally and chemically unstable, they decompose readily and are very hygroscopic. Experiments have shown that they can leave a doped material, when the material is exposed to air, and form oxygen-containing compounds. It is therefore advantageous to place alkali metals inside closed nanostructures' inner cavities for example inside a nanotube that is then closed at both ends. Alternatively the nanostructures can be intercalated with an alkali metal by vaporising the metal in a vacuum chamber containing the nanostructures. The unstable alkali metal-intercalated nanostructures are then reacted with an acid for example sulphuric, chlorosulphonic, selenic, perchloric, or hydrochloric acid or organic acids such as those based on tetracloroethylene, tetracyanoquinomethane, tetracyanoethylene, or 1,4-dicyanobenzene. The reaction takes place via sublimation of acid in a vacuum chamber containing the alkali metal-intercalated nanostructures or by impregnating the alkali metal-intercalated nanostructures with a hot, dry, solution, such as acetone, containing an acid. This process produces a stable acidic metal salt charge-transfer agent.

Charge-transfer shifts the fermi level of semiconducting nanostructures resulting in an enhanced conductivity. In this way the need to separate and remove all semiconducting nanostructures from manufactured nanostructure-containing material is avoided. Charge transfer to metallic nanostructures also enhances their conductivity.

A further advantage of applying a charge-transfer agent to conducting material containing nanoropes or nanofibres is that the charge-transfer agent separates individual nanotubes, which decreases their interaction and consequently the bandgap which arises because of said interaction.

A charge-transfer agent can be applied to nanostructures in many different ways such as by using a metal halide as a charge-transfer agent which can then be reduced using hydrogen. In another embodiment of the present invention electrolysis using an electrolyte containing a charge-transfer agent and an electrode comprising nanostructure-containing material is utilised. In a further embodiment of the invention the nanostructures are heated in the presence of a charge-transfer agent in a vacuum whereby a reaction takes place. In another preferred embodiment an alkali metal-containing nanostructure-based material is reacted with an acid to form an acidic metal salt. In a further preferred embodiment nanostructures are incorporated into a metal powder and sintered under pressure. The treatment of nanostructures with a charge-transfer agent can be carried out in either a batch process or a continuous process. Alternatively a charge-transfer agent can be added to the nanostructures during the production of the nanostructures.

In a preferred embodiment the nanostructure-containing material is impregnated by a fluid containing a charge-transfer agent, whereby a reaction takes place between the nanostructure-containing material and the charge-transfer agent.

In a preferred embodiment of the invention the nanostructures are embedded in a matrix. This means that the effective current density will be lower and that the electric field will be spread out over a larger area, which will reduce the concentration of the electric field in the vicinity of the conducting material and significantly increase the interface between the nanostructures and their surroundings.

According to preferred embodiments of the invention the matrix comprises at least one of the following materials: a metal such as a thin layer of vaporised gold, a polymer, a ceramic, a fluid, such as a liquid metal, a gel, a carbon-containing material or a combination of said materials. An advantage of having a metallic charge-transfer agent is that it reduces the contact resistance and improves the conductivity between individual nanostructures. The metallic charge-transfer agent also acts as a matrix. In a preferred embodiment of the invention the nanostructures are substantially uniformly dispersed in the matrix and the majority of them are oriented in a direction parallel to the conductor's length.

By using electromagnetic radiation, such as microwaves or light to irradiate nanostructures, excited electrons are produced. The electrons in the valence band of semiconducting nanostructures absorb electromagnetic radiation and cross the bandgap to the conduction band, which leads to an enhanced conductivity. In semiconducting nanostructures absorption can only take place if the irradiating energy is greater than the bandgap energy:

hv>E_{g}

where h is Planck's constant, v is the irradiation's frequency and E_{g} is the bandgap energy. In metallic nanostructures electrons are excited if they gain energy corresponding to at least the energy difference between the electrons' energy level and the fermi level.

### BRIEF DESCRIPTION OF THE DRAWING

A greater understanding of the invention may be obtained by reference to the accompanying drawing, when considered in conjunction with the subsequent description of the preferred embodiments, in which;

FIG. 1 shows a single-wall carbon nanotube's energy bands and the density of states (DOS) in the vicinity of the fermi energy

FIG. 2 shows the typical stepwise behaviour of a metallic carbon nanotube's conductance as a function of energy, and

FIG. 3 shows a power cable comprising conducting material containing nanostructures with enhanced conductivity according to a preferred embodiment of the present invention.

### DESCRIPTION OF PREFERRED EMBODIMENTS

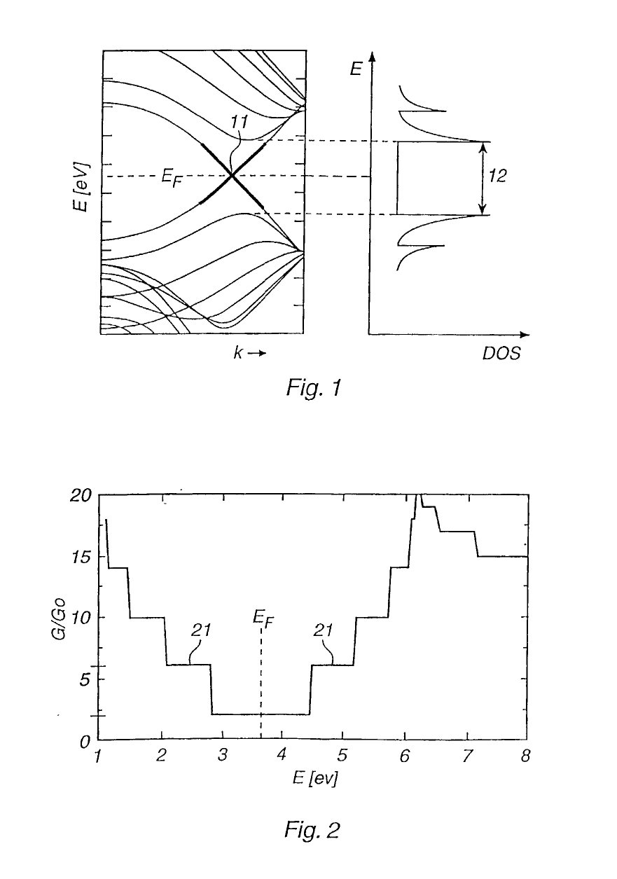

FIG. 1 shows energy bands and the density of states (DOS) of a metallic (5,5) carbon nanotube, whose fermi energy, E_{F}, is indicated with a dashed line. Two energy levels cross the fermi energy, 11. The density of states is finite and constant at E_{F}. The bandgap 12 between the next nearest DOS maximum is about 2 eV.

FIG. 2 shows a metallic (10,10) carbon nanotube's conductivity as a function of energy. The carbon nanotube's fermi energy, E_{F}, is 3.65 eV. If current is conducted at the carbon nanotube's fermi energy it's conductivity is 2G₀. If the carbon nanotube's fermi level is shifted up or down so that more energy levels cross the fermi level, the conductivity is enhanced in steps of 4G₀ to 6 G₀, 10 G₀ etc. In order to reach the first step 21, i.e. to increase the conductivity from 2G₀ to 6G₀, the fermi level has to be shifted up or down by about 0.8 eV. Theoretical estimates predict that to attain the necessary shift in the fermi level for a metallic (10,10) carbon nanotube, to increase the conductivity from 2 to 6G₀, a charge transfer corresponding to about 0.02 electrons per carbon atom is required.

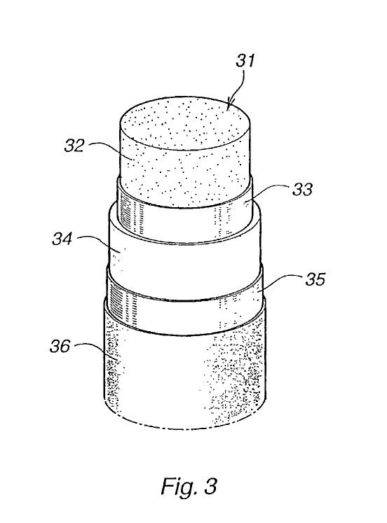

FIG. 3 shows a power cable comprising conducting material containing nanostructures with an enhanced conductivity according to the present invention. The nanostructures containing a charge transfer agent 31 are uniformly dispersed in a matrix material 32, forming the power cable's conducting material. The conducting material is surrounded by an inner semiconducting layer 33, insulation 34, an outer semiconducting layer 35 and an outer covering 36. The semiconducting layers 33, 35 form equipotential surfaces and the electric field is relatively uniformly spread out over the insulation material. In this way the risk of breakdown of the insulation material, because of local concentrations of the electric field, is minimised. In a preferred embodiment of the present invention the matrix material comprises a metal. The metal shifts the fermi level of the embedded nanostructures, decreases the contact resistance and improves the conductivity between individual nanostructures, which yields conductors with a high conductivity and low conduction losses. In another preferred embodiment a majority of the nanostructures are oriented in a direction parallel to the conductor's length.

Conducting material according to the present invention is intended for use in electric conductors for supplying electricity, in a quantum wire, in electric conductors for DC and AC transmission and for signal transmission within the communications field.

In another preferred embodiment the conducting material is irradiated with electromagnetic radiation of a suitable frequency to enhance the conducting material's conductivity.

1. An electric conductor including conducting material containing nanostructures (31), characterized in that the conducting material comprises a charge-transfer agent that is able to transfer charge between itself and the nanostructures, and that is adapted to shift the nanostructures' fermi level so that they attain an enhanced conductivity.

2. An electric conductor according to claim 1, characterized in that said charge-transfer agent is adapted to shift the nanostructures' fermi level so that more energy levels cross the fermi level than if the charge-transfer agent were excluded.

3. An electric conductor according to claims 1 or 2, characterized in that said fermi level shift results in an increase in the conductivity of said nanostructures of at least 0,01G₀, preferably 1G₀, more preferably 2 G₀ and most preferably 4G₀.

4. An electric conductor according to claims 1 or 2, characterized in that said nanostructures comprise at least one of the following: open or closed, metallic or semiconducting, single-wall or multi-wall nanotubes, nanospheres, nanoropes, nanoribbons or nanofibres.

5. An electric conductor according to claim 3, characterized in that said nanotubes, nanoropes, nanoribbons or nanofibres are woven, plaited or twisted to form a layer or a sheath.

6. An electric conductor according to any of the previous claims, characterized in that said charge-transfer agent is applied to the surface of the nanostructures.

7. An electric conductor according to any of the previous claims, characterized in that said charge-transfer agent comprises a charge carrier donor.

8. An electric conductor according to any of claims 1-6, characterized in that said charge-transfer agent comprises a charge carrier acceptor.

9. An electric conductor according to any of the previous claims, characterized in that said charge-transfer agent comprises at least one of the following: an alkali metal, an alkali metal-containing compound, an alkali earth metal, a transition metal, a halogen, a halogen-containing compound, an acidic metal salt, an acid, a polymer or hydrogen.

10. An electric conductor according to any of the previous claims, characterized in that said charge-transfer agent is placed inside the nanostructures' inner cavities.

11. An electric conductor according to any of claims 1-9, characterized in that said charge-transfer agent intercalates single-wall or multi-wall naotubes, nanoropes, nanoribbons or nanofibres.

12. An electric conductor according to claim 11, characterized in that said charge-transfer agent is a substance that decreases the interaction between nanostructures.

13. An electric conductor according to any of the previous claims, characterized in that said nanostructures are embedded in a matrix.

14. An electric conductor according to claim 13, characterized in that said matrix comprises at least one of the following materials: a metal, a polymer, a ceramic, a fluid, a gel or carbon-containing material.

15. An electric conductor according to claim 13, characterized in that said nanostructures are substantially homogeneously dispersed in said matrix.

16. An electric conductor according to any of claims 13-15, characterized in that a majority of said nanostructures are oriented in a direction parallel to the conductor's length.

17. An electric conductor according to any of the previous claims, characterized in that said conducting material is adapted to be irradiated with electromagnetic radiation to enhance the conductivity of the nanostructures.

18. A method of producing conducting material containing nanostructures, characterized in that said nanostructures are treated by reaction with a fluid containing a charge-transfer agent.

19. A method according to claim 18, characterized in that said nanostructures are made to react with a metal halide and are thereafter reduced using hydrogen.

20. A method according to claim 18, characterized in that an said nanostructures are treated by electrolysis using an electrolyte containing a charge-transfer agent and an electrode comprising nanostructure-containing material.

21. A method according to claim 18, characterized in that said nanostructures are heated with an alkali metal in a vacuum.

22. A method according to claim 21, characterized in that said alkali metal-containing nanostructures are made to react with an acid to form a stable acidic metal salt charge-transfer agent.

23. A method of producing conducting material containing nanostructures, characterized in that said nanostructures are incorporated into a metal powder and sintered under pressure.

24. A method of producing conducting material, characterized in that a charge-transfer agent is added to the nanostructures during their production.

25. A method according to any of claims 18-24, characterized in that said production is carried out as a batch process.

26. A method according to any of claims 18-24, characterized in that said production is carried out as a continuous process

27. The use of an electric conductor according to any of claims 1-17 to supply electricity.

28. The use of an electric conductor according to any of claims 1-17 in a quantum wire.

29. The use of an electric conductor according to any of claims 1-17 in DC transmission.

30. The use of an electric conductor according to any of claims 1-17 in AC transmission.

31. The use of an electric conductor according to any of claims 1-17 in signal transmission within the field of communications.
